(19) United States
(12) Patent Application Publication
(10) Pub. No.: US 2015/0370472 A1
(43) Pub. Date: Dec. 24, 2015

(54) 3-D MOTION CONTROL FOR DOCUMENT DISCOVERY AND RETRIEVAL

(71) Applicant: Xerox Corporation, Norwalk, CT (US)

(72) Inventors: Caroline Privault, Montbonnot-Saint-Martin (FR); Fabien Guillot, La Tronche (FR); Christophe Legras, Montbonnot-Saint-Martin (FR)

(21) Appl. No.: 14/309,300

(22) Filed: Jun. 19, 2014

(51) Int. Cl. G06F 3/0488; G06F 3/0482; G06F 3/041; G06F 3/0486; G06F 3/01; G06F 3/0481; G06F 3/0484

(52) U.S. Cl. CPC G06F 3/04883; G06F 3/04817; G06F 3/0482; G06F 3/04845; G06F 3/04842; G06F 3/0486; G06F 3/017; G06F 3/0416; G06F 2203/04104

(57) ABSTRACT

A processing method includes, associating each of a plurality of hand gestures that are detectable with a three-dimensional sensor with a respective one of a plurality of item processing tasks in memory. A plurality of graphic objects is displayed on a touch-sensitive display device, each graphic object being associated with a respective item. With the three-dimensional sensor, a hand gesture is detected. The respective one of the item processing tasks that is associated with the detected hand gesture is identified and the identified one of the item processing tasks is implemented on the displayed graphic objects, comprising causing at least a subset of the displayed graphic objects to respond on the display device based on attributes of the respective items. Item processing tasks may also be implemented through predefined touch gestures.

### BACKGROUND

The exemplary embodiment relates to document retrieval, filtering, discovery, and classification. It relates particularly to a system for assisted document review that combines existing 2D touch-based interactions with 3D user interaction control techniques.

Multi-touch interactive systems using specific user-interface designs and capabilities allow users to navigate easily through interactive content on a multi-touch screen, interactive table, or interactive window, all of which are referred to herein as tactile user interfaces (TUIs). TUIs incorporate a display device and a touch screen, which detects user hand or finger contacts or contacts of another implement with which a user contacts the screen, such as stylus. The detected movements are translated into commands to be performed, in a similar manner to conventional user interfaces that employ keyboards, cursor control devices, and the like. Such tactile user interfaces can be used for manipulating graphic objects, which can represent underlying documents.

However, translating the design of standard graphical user interfaces to multi-touch interactive devices is not always straightforward. This can lead to complex manipulations that the user may need to memorize in order to use the functionality provided by a touch screen application. Additionally, finger movements often lack the precision, which can be achieved with a keyboard, and fingers differ in size and shape, causing different touch signals to be sent from the touch screen to the application.

3D motion controllers are now commercially available which detect hand motions and convert them to commands to be performed by the user interface. However, adapting the 3D level of interaction to processes or services is complex, entailing careful consideration of the specific mode of interaction before being able to provide the interface that will be convenient for users. Additionally, 3D motion controllers tend to be highly sensitive and, even with the best tuning, the movement detection and returned effects are unstable. A human hand or finger cannot remain motionless in the air without slight changes in position. Additionally, precise pointing or tapping of an object displayed on the screen can be difficult for the user. Due to the real-time motion recognition and the high sensitivity of the sensor, the user has to control his gestures very carefully and be very precise while moving his hands or fingers in the air. This can become painful, thus disturbing and slowing down the interaction with the process and the task to be accomplished.

For example, in the case of a large set of documents to be reviewed and classified, the repeated user actions of dragging each object, reviewing it, and then moving it to a selected file or other action may become wearing on the reviewer after an hour or two of such actions, or even several minutes.

Additionally, the cone-shaped interaction zone of some 3D motion controllers where the user can interact is relatively small. The recommended distance from the device is about 25 cm and beyond about 35 cm, the recognition precision drastically falls. Depending upon the installation and environment, the user may perform gestures outside of the zone or too close to the limits, leading to poor performance.

There is a need for a user interactive system that does not require a user to precisely point to a specific widget or element displayed on a screen to trigger an action.

### INCORPORATION BY REFERENCE

The following references, the disclosures of which are incorporated herein in their entireties by reference, are mentioned:

U.S. Pub. No. 20100313124, published Dec. 9, 2010, entitled MANIPULATION OF DISPLAYED OBJECTS BY VIRTUAL MAGNETISM, by Caroline Privault, et al.

U.S. Pub. No. 20120216114, published Aug. 23, 2013, entitled QUERY GENERATION FROM DISPLAYED TEXT DOCUMENTS USING VIRTUAL MAGNETS, by Caroline Privault, et al.

U.S. Pub. No. 20130194308, published Aug. 1, 2013, entitled REVERSIBLE USER INTERFACE COMPONENT, by Caroline Privault, et al.

U.S. Pat. No. 8,165,974, issued Apr. 24, 2012, entitled SYSTEM AND METHOD FOR ASSISTED DOCUMENT REVIEW, by Caroline Privault, et al.

### BRIEF DESCRIPTION

In accordance with one aspect of the exemplary embodiment, a document processing method includes associating in memory each of a plurality of hand gestures that are detectable with a three-dimensional sensor with a respective one of a plurality of item processing tasks. The three-dimensional sensor is associated with a touch-sensitive display device. At least one hand contact which is detectable with the touch-sensitive display device is associated with at least one of the plurality of item processing tasks. A set of graphic objects is displayed on the touch-sensitive display device, each graphic object being associated with a respective item. With the three-dimensional sensor, a hand gesture is detected and the respective one of the item processing tasks that is associated with the detected hand gesture is identified. The identified one of the item processing tasks is implemented on the set of displayed graphic objects. This includes causing at least a subset of the set of displayed graphic objects to respond on the display device based on attributes of the respective items.

In accordance with another aspect of the exemplary embodiment, an interactive user interface for processing items includes a display device. A three-dimensional sensor for detection of hand gestures is positioned adjacent the display device. Instructions are stored in memory for associating each of a plurality of hand gestures that are detectable with a three-dimensional sensor with a respective one of a plurality of item processing tasks, at least one of the item processing tasks being associated with a touch gesture detectable by the touch-sensitive display device; displaying a set of graphic objects on the display, each graphic object representing a respective item; with the three-dimensional sensor, detecting a hand gesture; identifying the respective one of the item processing tasks that is associated with the detected hand gesture; and implementing the identified one of the item processing tasks on the displayed graphic objects, including causing at least a subset of the displayed graphic objects to respond on the display device based on attributes of the respective items. A processor is in communication with the memory and display for executing the instructions.

In accordance with another aspect of the exemplary embodiment, a method for using 2D and 3D motion control on a common user interface includes providing for receiving a 2D gesture on a graphic object displayed on a tactile user interface from a user's hand and, using a 3D sensor, capturing an orientation of a hand of the user. With a processor, a location of the user in relation to the tactile user interface is computed from the hand orientation. The graphic object may be repositioned on the tactile user interface, based on the detected hand orientation, such that the graphic objects are viewable by the user in a correct orientation to the user's location. Alternatively or additionally, a workspace boundary is created around the graphic objects of each of a plurality of users such that each user's hand gestures are used for implementing an item processing task on the displayed graphic objects within the respective boundary.

### BRIEF DESCRIPTION OF THE DRAWINGS

FIG. 1 illustrates an embodiment of a tactile user interface with a 2D surface and a 3D sensor, in accordance with one aspect of the exemplary embodiment;

FIG. 2 illustrates a functional block diagram of an exemplary apparatus incorporating the tactile user interface in accordance with another aspect of the exemplary embodiment;

FIG. 3 illustrates an exemplary method for configuring a 2D interface and document review in accordance with another aspect of the exemplary embodiment;

FIG. 4 illustrates configuring hand gestures in another aspect of the exemplary embodiment;

FIG. 5 illustrates positive category filtering for a group of graphic objects in another aspect of the exemplary embodiment;

FIG. 6 illustrates positive category filtering and subsequent movement of the matching documents to another location based on a user's hand movement;

FIG. 7 illustrates positive or negative filtering based upon the height of a user's hand in another aspect of the exemplary embodiment;

FIGS. 8 and 9 illustrate clustering of a group of documents based on hand gestures in another aspect of the exemplary embodiment;

FIG. 10 illustrates a method for orientating displayed documents with respect to a user's location and creating workspace boundaries in another aspect of the exemplary embodiment;

FIG. 11 illustrates document orientation based upon a user's location in the method of FIG. 10; and

FIG. 12 illustrates workspace boundaries based upon user location in the method of FIG. 10.

### DETAILED DESCRIPTION

Aspects of the exemplary embodiment relate to a multi-touch tactile user interface (TUI) for manipulating graphic objects representing items such as text documents or images and methods for and sorting, e.g., classifying, filtering, retrieving, and/or clustering documents and other items quickly and easily using 2D and 3D interaction techniques.

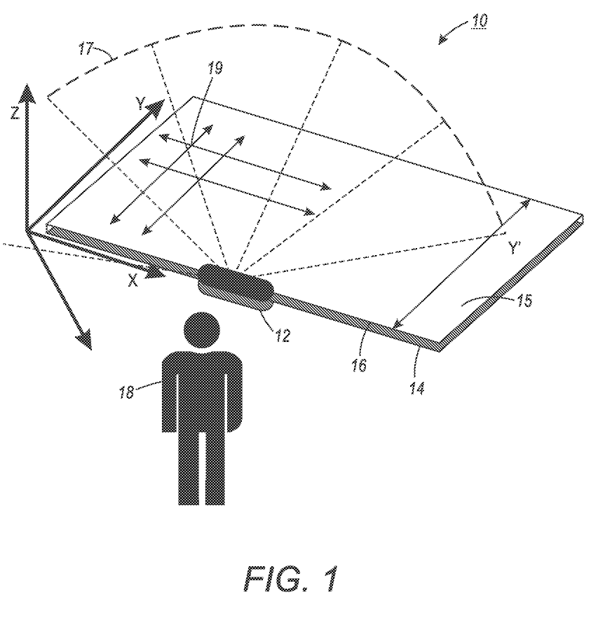

FIG. 1 illustrates an exemplary interactive user interface 10. The interactive user interface 10 combines a 2D touch-based interaction system with a 3D control interaction system. The combined interface 10 allows a user to control a document processing task, such as a document retrieval and discovery task, through a combination of two dimensional and three dimensional gestures.

The interactive user interface 10 includes a three-dimensional (3D) sensor 12 and a 2D touch-sensitive display device 14, such as an LCD or plasma screen, computer monitor, or the like, which may be capable of displaying in color. The illustrated display device 14 serves as a tactile user interface and includes a touch screen 15, which includes multiple actuable areas, which are independently responsive to touch or close proximity of an object (touch-sensitive). The user-actuable areas may be pressure sensitive, heat sensitive, and/or motion sensitive. The actuable areas may form an array across the touch screen 14 such that touch contact within different areas of the screen may be associated with different operations. Hand contacts detectable with the touch sensitive display device 14 are associated with item processing tasks.

The 3D sensor 12 is located adjacent the display device 14, such as centrally located with respect to a border 16 of the display device so that 2D and 3D gestures can be detected by the sensor 12 and touch screen 15 while keeping the hand within a few centimeters, such as up to 30 cm, from the touch screen 15. The 3D motion sensor 12 receives signals from a 3D detection zone 17 which may cover all or a portion of the 2D touch-based display device 14. The detection zone may be approximately conical. This allows a user 18, positioned proximate the 3D motion sensor 12, to interact with the system 10 in the x, y, and z directions. The x and y directions define a plane of the touch screen 15. The exemplary 3D sensor 12 senses how a user moves and/or positions his hands and fingers in a wide-open space around the display device without the need for the user to touch any part of the user interface 10. In one embodiment, the 3D sensor 12 is a 3D motion sensor which uses a combination of radiation sources and corresponding radiation detectors (not shown) to track user movement in the zone 17. By way of example, the radiation sources may include three or more infrared LEDs and the detectors may include two or more infrared cameras. An example sensor of this type is a Leap Motion Controller, available from Leap Motion, Inc., San Francisco, Calif. This controller is a USB device using two monochromatic IR cameras and three infrared LEDs, which observes a roughly hemispherical area, to a distance of about 1 meter. Rather than being placed with its radiation sources and sensors facing upward, as for other applications, such a device can be angled to detect hand motions over the table. The sensor 12 detects shape and movements of a user and the sensed user information is converted into controls (gestures made of coordinates and metadata, which can be associated in memory with predefined processing tasks) and graphics (e.g., by visualizing responses of displayed graphic objects to a predefined processing task). An item processing task may be performed through 3D motion/position gestures, 2D touch gestures, or a combination thereof. In some embodiments a user can chose whether to implement a given processing task with 2D touch gestures, with 3D hand gestures, or with a combination of the two.

The touch screen 15 may have a depth y′ (in the y direction) which is long enough to fit at least a portion of the length of the user's arm. The user 18 may manipulate and sort graphic objects in a 2D space 19 defined in the x and y directions by touching the screen 15 of the 2D touch-based display 14. The touch screen 15 receives signals from the 2D detection zone 19 defined by the surface of the touch screen 15. When the 3D motion sensor 12 is oriented on the border of the 2D touch-based display device 14, or otherwise proximate the display device, the user may also or alternatively utilize the 3D motion sensor 12 to manipulate and sort graphic objects in the 3D space 17.

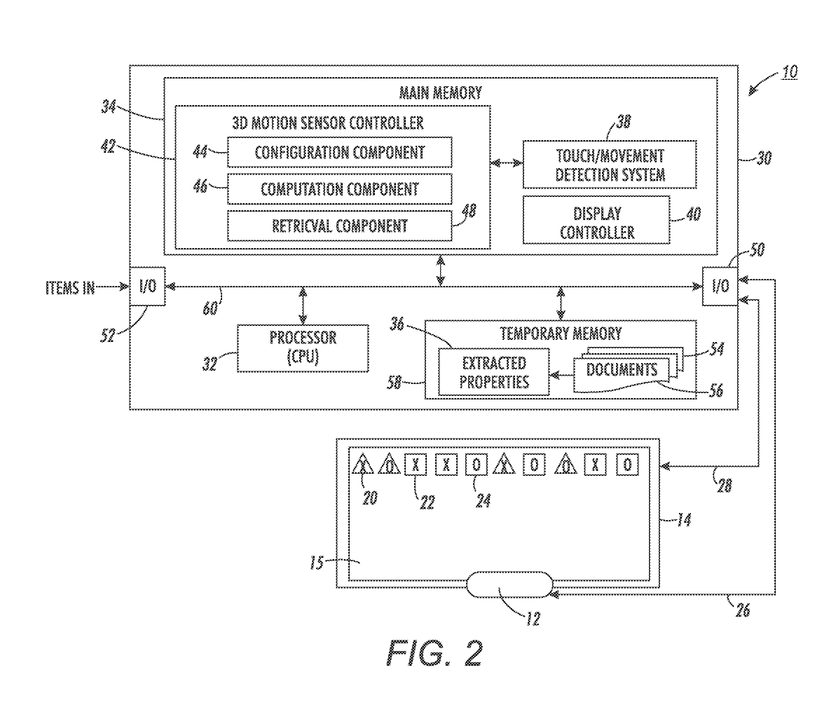

FIG. 2 is a functional block diagram which illustrates aspects of the interactive user interface 10. The display device is configured for displaying a set of graphic objects 20, 22, 24, which can be manipulated by a user via 2D and/or 3D interactions. Each graphic object if defined by a collection of pixels, and may have a predefined shape and/or color.

The display device 14 and 3D sensor 12 are operatively connected, via wired or wireless links 26, 28, with a computer device 30. The computer device 30 may be integrated into the display device 14 or may be external to the display. The computer device 30 includes a processor 32, in communication with main memory 34 and temporary memory 36. Main memory 34 stores computer program instructions for implementing the display and touch screen functionality as well as the 3D motion sensor 12 functionality. In particular, the computer memory 34 stores a detection system 38 which detects hand movements in the zone 17 and/or the locations of finger contacts with the touch screen 15 and movements of the fingers across the screen. In some embodiments, separate detection components are provided for processing the 2D and 3D signals received from the touch screen 15 and sensor 12, respectively. Memory 34 also stores a display controller 40, which controls the content of the display. Parts of the components 38, 40 may form a part of the software supplied with the touch screen device 14. Components 38, 40 may include additional instructions for manipulation of graphic objects though touch-based 2D interactions, as described in copending U.S. Pub. Nos. 20100313124, 20120216114, and 20130194308, incorporated herein by reference.

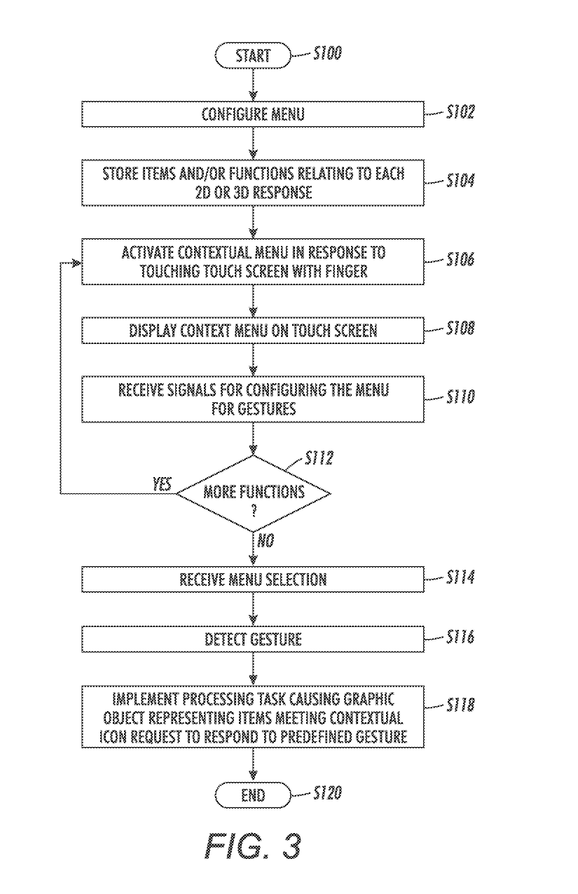

In addition, a 3D sensor controller 42 receives signals from the 3D motion sensor 12 via the detection system 38, and supplies control signals to the display controller 40 for controlling the movement of the graphic objects 20, 22, 24 in response to the 3D motion sensor 12 commands. The 3D motion sensor controller 42 includes processing instructions stored in memory 34, which are executed by the associated processor 32. In particular, the processor executes computer program instructions, stored in memory 34 for implementing the method described below with reference to FIG. 3 and/or 10. The instructions include a configuration component 44, a computation component 46, and a retrieval component 48. The raw signals received by the detection component 38 from the sensor 12 are converted, by suitable software, into a representation of the hand position and/or movement which is suitable for processing by the configuration component 46 and association with an assigned document processing command. For example, the detection component may output, for each of a plurality of closely spaced time intervals, positions of a fixed number of points on the user's body, rather like a skeleton, such as one or more of: the fingertips, one or more finger joints, center of the palm, palm orientation, wrist, and one or more locations on the forearm, which can be used by the configuration component to generate a representation of the gesture which allows for an approximate matching with a similar gesture made by a user at a later time. This allows gestures which are close to the stored representation of the gesture to be recognized, without the need for the user to match the stored gesture exactly in terms of the 3D configuration of the hand or its position relative to the screen. The computation component 46 performs computations on attributes of stored documents, e.g., for classification and/or clustering. The retrieval component displays documents which are responsive to an identified document processing command.

An input and output interface 50 allows the computer 30 to communicate with the display device 14 and receive touch signals from the touch screen 15 and 3D motion signals from the 3D motion sensor 12. Another input/output interface 52, such as a modem, intranet or internet connection, USB port, disk slot, or the like, allows documents 54, 56, other items, and/or pre-computed attributes 58 thereof to be input from an external source and stored in temporary memory 36. The components 32, 34, 36, 50, 52 of the computing device 30 may communicate via a data/control bus 60.

Once the 3D motion sensor controller 42 is configured, it can be used to cause objects such as graphic objects 20, 22, 24 and/or displayed documents to exhibit a response to predefined gestures, such as positions and/or movements of the user's body, e.g., hand, finger, and/or wrist movements/positions, and the like. These can be used to manipulate the objects and cause them to move across the screen or to exhibit other predefined response. The 3D motions may be used to move objects across the screen from their original positions to a new position, based upon the user movement within the zone of interaction 17. In some embodiments, the response exhibited by the graphic objects may include a change in visible properties such as size, color, shape, highlighting, or a combination thereof.

The graphic objects which respond to one of the predefined 3D gestures may depend on the gesture that is employed and also on the hand position over the screen. For example, graphic objects displayed on the screen that are not within a threshold distance, in the x-y plane, from the hand may exhibit no response to the gesture or may exhibit a lesser response which is a function of distance, in the x-y plane. For example, a selected processing task is implemented only on the set of displayed graphic objects over which the user's hand spans. The third, z dimension may also or alternatively be used to effect a change in response.

Tapping on one of the displayed graphic objects 20, or performing a predefined 3D gesture, causes the underlying document 54 to be opened and displayed on the screen 15. In one embodiment, the displayed graphic objects represent a set of electronic text documents 54, 56, etc., which are stored in temporary memory 36. The attributes 58, in this case, can be based on the frequencies of keywords found in the graphic objects, cluster based attributed, generated by automatically assigning the graphic objects to one of a predetermined clusters based on similarity, or any other attribute which can be extracted from the document such as date sent, author, metadata, document size, document type, image content, and the like.

In another embodiment, the displayed graphic objects 20, 22, 24 may represent a set of stored digital images 54, 56, in which case the displayed graphic objects may be icons or thumbnails of images. The attributes, in this case, may be low-level features of the images, such as color or texture, or higher-level representations of the images based on the low-level features.

The items 54, 56, however, are not restricted to text documents or images. Indeed the displayed objects may represent any items, tangible or digital, for which attributes of the item can be extracted.

The displayed graphic objects 20, 22, 24 differ in their response to predefined 2D and/or 3D user gestures, allowing one or more of the displayed graphic objects to respond to the user interactions. As an example, a predefined 3D or 2D user gesture may cause one of the graphic objects to be separated from other objects. A set of one or more items corresponding to the separated displayed object can be displayed and processed by the user using further predefined 2D and/or 3D user gestures. In one exemplary embodiment, the graphic objects can be classified according to the presence or absence of attributes, such as a keyword or the like. A predefined hand gesture (touch or 3D) implements a classification mode. In the classification mode, a classifier separates the documents into one or more classes based on their attributes. The attributes may be precomputed or classification may be based on the full textual content (e.g., on the fly categorization through a predictive text classification model, which may be, for example, machine-learning-based). Upon classifying a document based on its attribute(s), a further pre-configured gesture, such as a hand motion, may cause the graphic object corresponding to that document to move on the screen away from the remaining graphic objects as a predefined response. In other embodiments, the objects are identified, classified and grouped based upon a relative matching score. The exemplary interactive user interface 10 thus provides a user with means for classifying, filtering, and/or retrieving graphic objects, and the items they represent, quickly and easily.

Exemplary attributes 58, which may be extracted from the documents 54, 56, include presence or absence of specified keywords, document size, a class assigned to the document, e.g., stored in meta data, a function describing the similarity of the document to a predefined document or set of documents, or the like. These attributes maybe pre-stored, or pre-calculated and stored in a data base; or they can be computed on-the fly from the document content and/or other attributes e.g., a calculation of a probability score that the document belongs to a classifier category, or a level of similarity with another document.

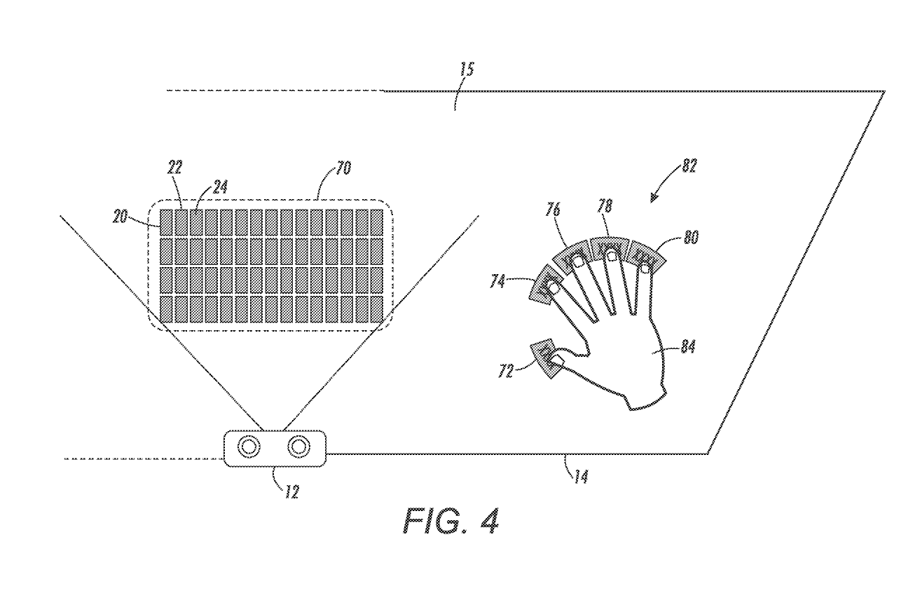

Contextual menu icons 72, 74, 76, 78, 80 of a menu 82 displayed on the touch screen 15 (FIG. 4) allow the user to select, e.g., through touching one of the icons displayed on the screen, one of a set of predefined tasks which make use of the attributes of the items and, thereafter, to implement the task primarily through performing one or more of the predefined three dimensional gestures.

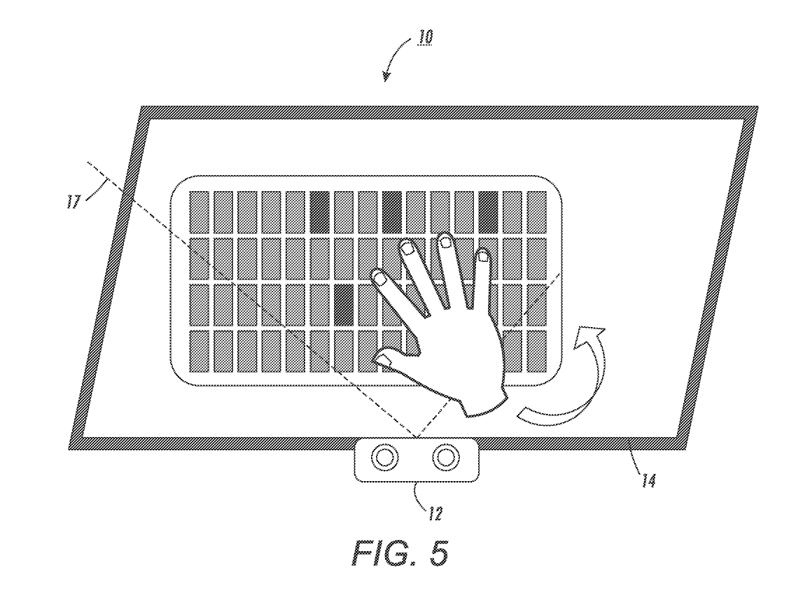

Using touch of a finger on the user's hand 84 (FIG. 5) or a pre-configured 3D motion movement or other hand gesture, graphic objects 20, 22, 24, etc., are attracted or repelled. For example, objects may be caused to be attracted to a finger or other visible part of the hand and move from their original place on the touch screen 15 and move closer to the finger, or exhibit another visible response to the hand gesture.

The processor 32 may be the computer 30′s CPU or one or more processing devices, such as a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the flowchart shown in FIG. 3, can be used as the processor.

Computer-readable memories 34, 36, which may be combined or separate, may represent any type of computer readable medium such as random access memory (RAM), read only memory (ROM), magnetic disk or tape, optical disk, flash memory, or holographic memory. In one embodiment, the computer memory 34, 36 comprises a combination of random access memory and read only memory. In some embodiments, the processor 32 and memory 34 may be combined in a single chip.

The term “software” as used herein is intended to encompass any collection or set of instructions executable by a computer or other digital system to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 3 illustrates an exemplary method for employing the interactive user interface 10. The method begins at S100.

At S102, a contextual menu may be configured, allowing the interactive user interface 10 to be used for one or more processing tasks, such classification, clustering, or other processing tasks involving sorting items, such as documents. In one embodiment, each of a plurality (i.e., two or more, such as 2, 3, 4, 5, 6, or more) of different user gestures in which the user's hand 84 interacts with the 3D sensor may be stored and associated with a respective item processing task. Each processing task may be associated with a respective one or more contextual menu icons 72, 74, 76, 78, 80 of a menu 82 which is displayable on the touch screen 15 (FIG. 4). In some embodiments, a user interacts with the interface to define the gestures which are to be associated with document processing tasks. In other embodiments, the configuration may be automatic, based on the output of the movement detection system 38 (as in a clustering task where when the movement detection system recognizes a display of two fingers, this is programmed to be associated with two clusters by the controller 34).

At S104, items such as documents 52, 54, are received and stored in memory 36. For each item, a corresponding graphic object in a set of graphic objects to be displayed is associated with the item.

At S106, the pre-configured contextual menu 82 may be activated by a user gesture, such as touching the screen with a user finger or moving the hand in the 3D space. The user interaction is detected by the touch screen 15 or sensor 12 and signals corresponding thereto are received by the detection component 38 of computer 30. There may be different user gestures associated with different modes of operation, such as a first user gesture for classification which brings up a menu adapted to classification of documents and a second user gesture for clustering, which optionally brings up a menu adapted to clustering of documents, and so forth.

At S108, the contextual menu 82 is displayed on the touch screen, for example, around the fingers of the hand. To select a particular command to configure it for performing an action, a finger on the user's hand 84 may be used to tap one of the contextual menu icons 72, 74, 76, 78, 80, and a signal corresponding to the touch is received by the configuration component 44 at S110. In one embodiment, the menu options may correspond to different search and retrieval criteria such as keywords, which may be predefined or selected by the user. In other embodiments, each icon represents a respective category label corresponding to a class for which a predictive classifier has been trained to score documents with respect to the class. The user performs the gesture which is to be associated with this menu option. This is detected by the 3D sensor and a signal corresponding thereto is received by the configuration component 44. This allows the user to configure the gesture corresponding to this menu option. The process may continue until there are no more functions to be configured S112. If the contextual menu 82 is already displayed on the display 14, a user can continue with the configuration by selecting a different menu option.

Once the contextual menu 82 has been configured, manually or otherwise, the user can select one of the menu options, for example, by touching the screen to activate the contextual menu 82 again and selecting one of the menu options by touching one of the icons, and the user's selection is received by the computer. For example, a classification operation can be activated by touching the touch screen 15 in the 2D space or by moving the user's hand 84 in the 3D space (i.e., through a touchless gesture) over a group of documents 52, 54 displayed on the touch screen 14. In the illustrated embodiment, the user touches, e.g., taps, one of the icons displayed in the wheel menu 82, each icon being positioned close to a respective user's finger placed on the screen for ease of operation.

The menu 82 optionally has a second (or more) level of options that appear once a particular category has been selected through a first finger tap on one of the icons 72, 74, 76, 78, 80. The second level of options may also be displayed in a wheel menu style, with each option close to a user's finger placed on the screen. In one embodiment, in the case of a classification task, each second level option is a respective threshold on the predicted classifier scores for the selected category (i.e., category previously selected at the first level).

For example, the second level menu may have a plurality (e.g., 2, 3, 4, 5, or more) options that may correspond to different numerical values, such as 20%, 40%, 60%, 80% and 95%, which are all thresholds on probability scores to belong to the given category. A user can select one of the thresholds by tapping the respective second-level icon.

At S116, the user positions/moves the hand in the 3D space and the predefined gesture is detected by the detection system 38 and converted by the configuration component 44 into instructions for performing a document processing action. Graphic objects corresponding to the documents, or the displayed documents, are thus caused to exhibit a response to the request (S118).

For example, in the case of a classification task, graphic objects corresponding to documents 52, 54 that meet the request, e.g., meet or exceed a threshold classification score for the selected class, become reactive and are highlighted or move close to the hand location. The graphic objects can be moved to one side of the screen 15 or another based upon the user's gesture(s). A variety of hand gestures are contemplated. For example, a hand positioned palm-down may be detected by the 3D motion sensor 12 and cause a response for documents which are positive for a given class, while flipping the hand to a palm-up position may be detected by the 3D motion sensor 12 and interpreted as filtering the documents 52, 54 from the negative category (or vice versa).

In another embodiment, a movement or position gesture relative to the screen surface 15 along the z axis may modify a classification threshold and thus affect the number of documents which are responsive.

In another embodiment, a clustering function may be implemented by using the fingers for selecting a number of clusters (e.g., from 2 to 5 clusters could be selected using one hand, or more clusters using two hands) and launching the clustering of a document set into that specified number of clusters.

In another embodiment, documents 52, 54 displayed on the screen are caused to snap to a position suitable for viewing by inferring the position of the user, relative to the display device, based on detecting two or more positions on the user's hand 84.

The method ends at S120.

Further details of the system and method will now be described.

### Document Review

The classification action using 2D and/or 3D gestures as described herein reduces the number of repetitive user actions, which would otherwise be employed by a user to separate, review, and process a large number of documents. As described herein, positive document filtering encompasses any rule that enables filtering out of a subset of documents through, for example, predefined keyword based searching criteria. Negative document filtering as described herein includes any rule that enables filtering out of a subset of documents that do not meet a specific predefined keyword.

A keyword or attribute search can be conducted through document classification, which can employ any automatic classifier implemented through an algorithm, which is able to associate a predefined label to a document based on text, graphic or other attribute, and return all documents that include or exclude that keyword or meet a predefined threshold relating to presence/absence of the keyword or other attribute. A simple keyword search filter may be built with a function such as: if the item contains the word “confidential” and either “attorney” or “privilege” then the function is met and the command requires the graphic object representing the item to exhibit a response.

With reference to FIG. 4 graphic objects 20, 22, 24 may be initially arranged on the display device screen in an arrangement 70, such as wall of tiles. The classification mode may be associated with a predefined touch gesture. For example, the user touches the screen with all five fingers to initiate the classification mode. When the user's hand 84 touches the screen in this way, the contextual menu 82 is displayed. The menu options may be displayed in an arc so that they are easily reached by respective fingers of the same hand, positioned adjacent the screen. A user may select one of the classification tasks, such as a keyword for performing a search or one of a set of pre-learned classifier models, from the displayed menu, by touching a respective one of the icons 72, 74, 76, 78, 80.

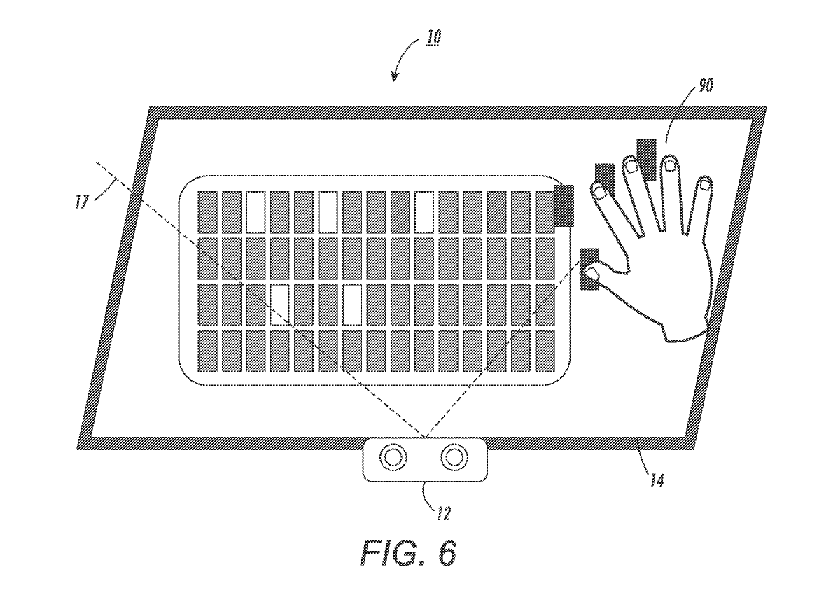

Once the classification task has been selected, for example, with the appropriate touch gestures, a 3D (e.g., touchless) hand gesture or gestures can then be used to implement the classification task on the documents. With reference to FIGS. 5 and 6, for example, the classification of documents 52, 54 is illustrated in one example embodiment. In FIG. 5, the user performs a predefined 3D gesture, here placing a hand palm-down with fingers spread apart from each other, and the gesture is detected by the sensor 12 and corresponding signals sent to the detection system 38. These are processed and a representation of the gesture generated therefrom is compared to one or more stored gestures by the configuration component. If the stored and performed gestures are sufficiently similar, the gestures are considered a match and the corresponding predefined command is implemented.

As an example, graphic objects representing documents 52, 54 responsive to a classification task are highlighted, such as those representing documents which are positive for the class. Flipping the user's hand 84 over to a palm-up position causes graphic objects from the negative class (or a second class) to be highlighted.

Documents can be thus classified through a keyword or other search action. When a gesture of the user's hand 84 has been configured as described above, the keyword search or other classification task is obtained by moving the user's hand 84 over a group of graphic objects displayed on the touch screen 15. Documents 52, 54 that meet the task request are identified and their respective graphic objects become reactive and become highlighted and/or move across the screen, e.g., closer to the hand location.

Documents can also be classified through an on-line textual classifier (e.g., a machine-learning based classifier, such as a Probabilistic Latent Semantic Analysis (PLSA) model). When a gesture of the user's hand 84 has been configured for on-line text classification, an on-the-fly classification is obtained by moving the user's hand 84 over a group of graphic objects displayed on the touch screen 15. Documents 52, 54 that meet a predetermined threshold probability of being in the considered class are identified and their respective graphic objects become reactive and become highlighted or move closer to the hand location.

As shown in FIG. 6, a predefined 3D movement gesture, such as moving the hand generally parallel to the screen, away from the arrangement 70, is sensed by the 3D sensor and causes a subset 90 of the graphic objects (the highlighted ones), to move to another location. To drag the documents away from the document set, the user causes his hand to hover over the display screen 14 and moves the hand to another location over the display screen 14. This action is sensed by the 3D sensor and causes corresponding movement of the highlighted documents. When the graphic objects have been moved to the user's selected location, the graphic objects can be released by performing another predefined gesture, such as closing the hand at the current location over the display screen 14. This predefined gesture is sensed by the 3D sensor and stops the hand attraction and the graphic objects become stationary.

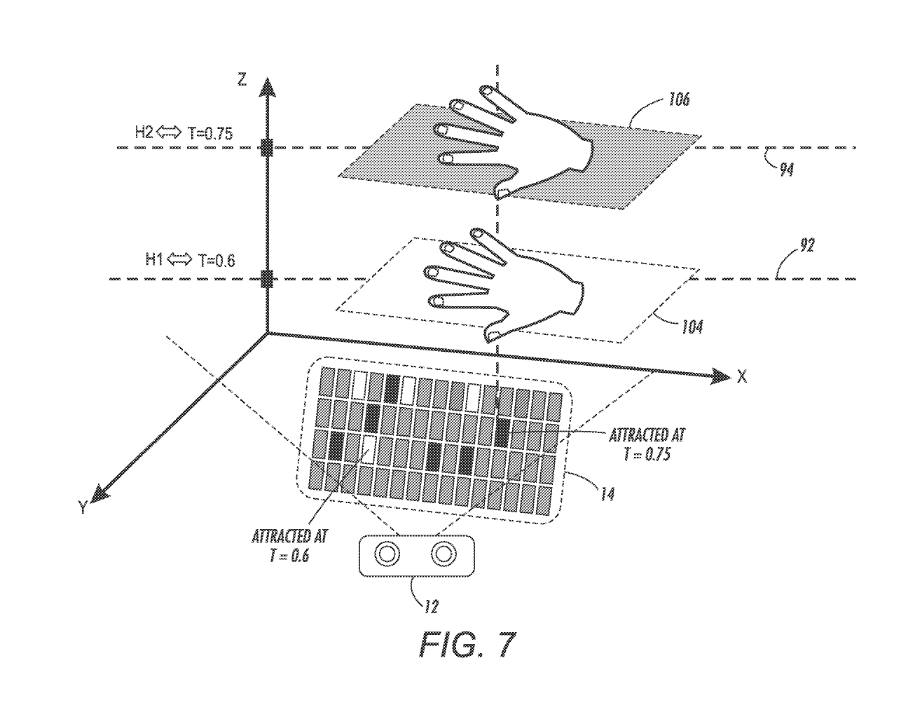

As illustrated in FIG. 7, selective filtering of documents against a positive or negative category can be performed using a user's hand height. The sensor detects a relative position of the hand, e.g., with respect to the 2D screen surface, and this is converted to a height along the z axis. One or more predetermined thresholds 92, 94 on height may be established, which are associated with the classification task and translated into different levels of classification with respect to a given class, such as respective thresholds on classification scores for the given class. Upon gesturing above the display, a subset of the set of graphic objects displayed on the screen which meet the closest threshold below the hand are caused to respond to the gesture. For example, the underlying documents are evaluated against an existing classifier. The classifier outputs a probability score for each document with respect to the class. Only documents that have a probability score above the selected score threshold are highlighted or become reactive. The user's hand 84 height above the display 14 determines which threshold to apply on the computed probability scores for identifying the responsive documents. As illustrated in FIG. 7, when the hand is positioned in a plane 104 above the lower threshold 92, graphic objects representing documents meeting the lower threshold 92 on their class probability score are highlighted (as well as those which meet the higher threshold). At the lower height, more documents match. If the user wishes to filter more documents out of the remaining set, the user can place his hand at a higher point 106 above the display screen 15, above the second threshold 94, thus increasing the matching threshold and retrieving less documents, (e.g. classification scores may need to have probability of over 90% of belonging to the class for a document to be responsive to the classification task). Using a user's hand height, 2 or 3 height thresholds can readily be distinguished by the user, although more than three thresholds may be possible in some circumstances.

Filtering may also be applied to a single document. When a document is open and displayed for reading on the touchscreen 15, moving the user's hand 84 over the displayed text triggers the classification of that document 52, 54. In return, the probability of that document 52, 54 against the selected category will appear, for instance displayed as a watermark over the document 52, 54, e.g., “75% probability to belong to category C”. Alternatively, responsive parts of the document, e.g., fragments of the text which are responsive to the classification task are displayed (e.g., the fragments are highlighted using different color, font style, or appearing to be lifted up from the document, or the like).

### Clustering

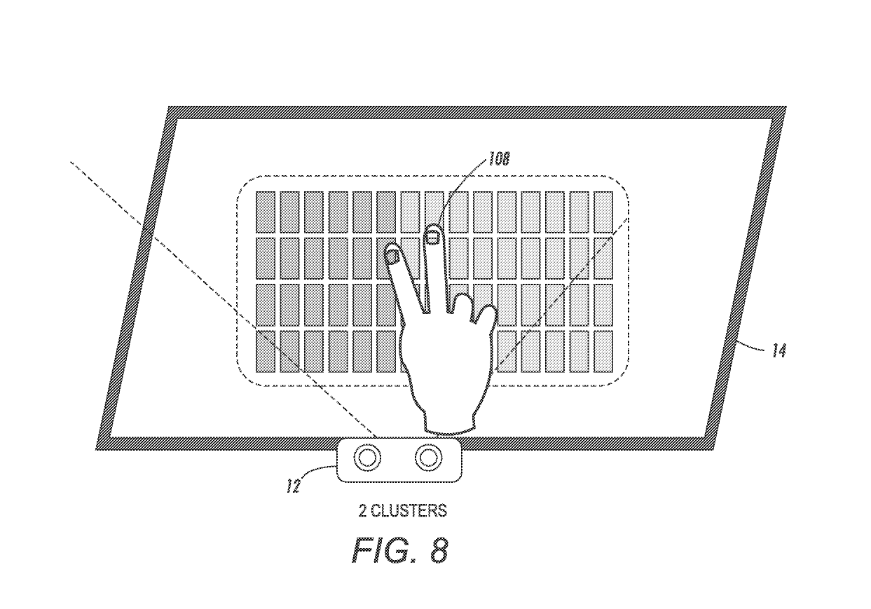

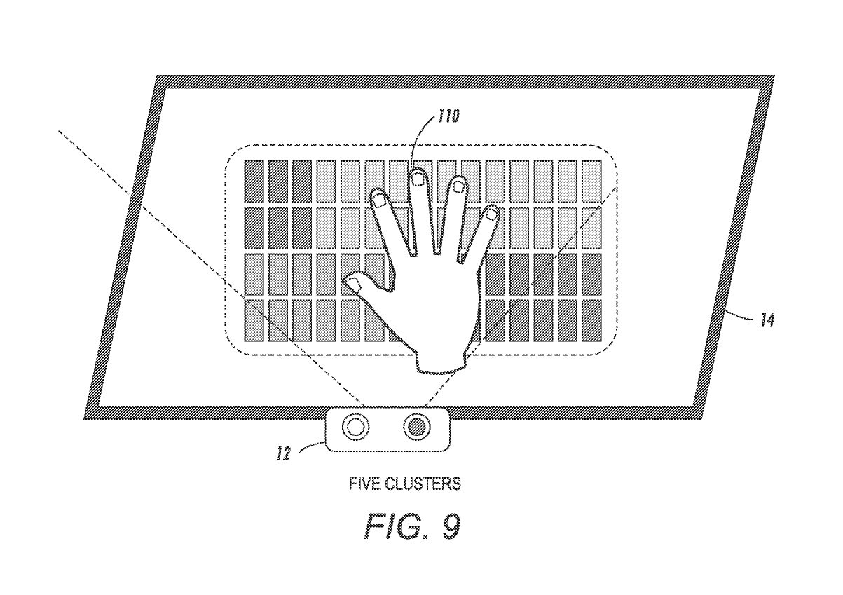

With reference to FIGS. 8 and 9, once the contextual menu is configured, the user's hand 84 can be used as a clustering tool. The association to the clustering action may begin by touching the 2D area of the display screen 15 to activate the configured contextual menu 82 around the hand. The clustering function is selected through one or several contacts on the display screen 15 and/or by displaying a number of fingers corresponding to the desired number of clusters. Once the hand gesture has been programmed, the document clustering is obtained by moving the user's hand 84 in the 3D space over a group of graphic objects displayed on the display screen 15 (through a touch-less gesture). As the 3D motion controller 42 recognizes each of the fingers on the user's hand 84, the number of clusters to be formed is indicated by the user's hand 84 showing the number of fingers (e.g. 2 fingers for 2 clusters 108, 3 fingers for 3 clusters, 4 fingers for 4 clusters, and 5 fingers for 5 clusters 110) Once the action is recognized, the graphic objects 20, 22, 24 are reorganized into clusters through an animation that can move and regroup the objects displayed on the screen 15 and/or by using a different color for each cluster. When working on text documents, the clustering action once recognized can trigger a text clustering engine, (e.g., PLSA for Probabilistic Latent Semantic Analysis). The algorithm determines to which cluster each document should belong, and the corresponding graphic objects 20, 22, 24 are reorganized into these computed clusters on the screen display.

### Collaborative Review

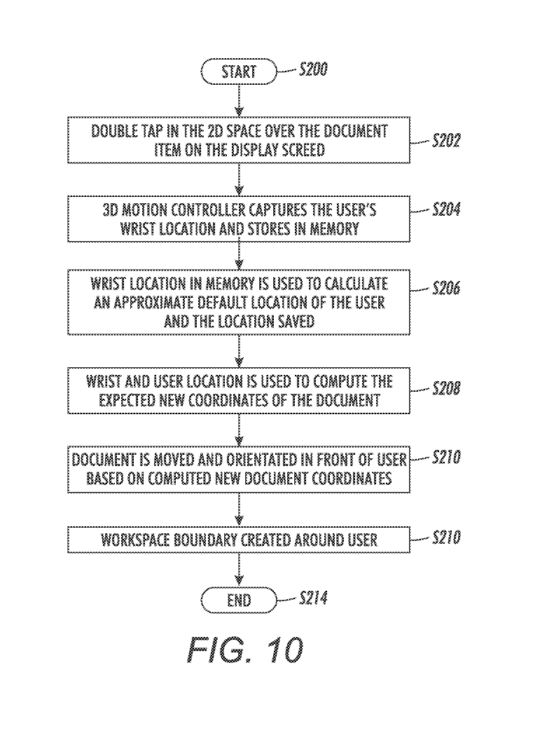

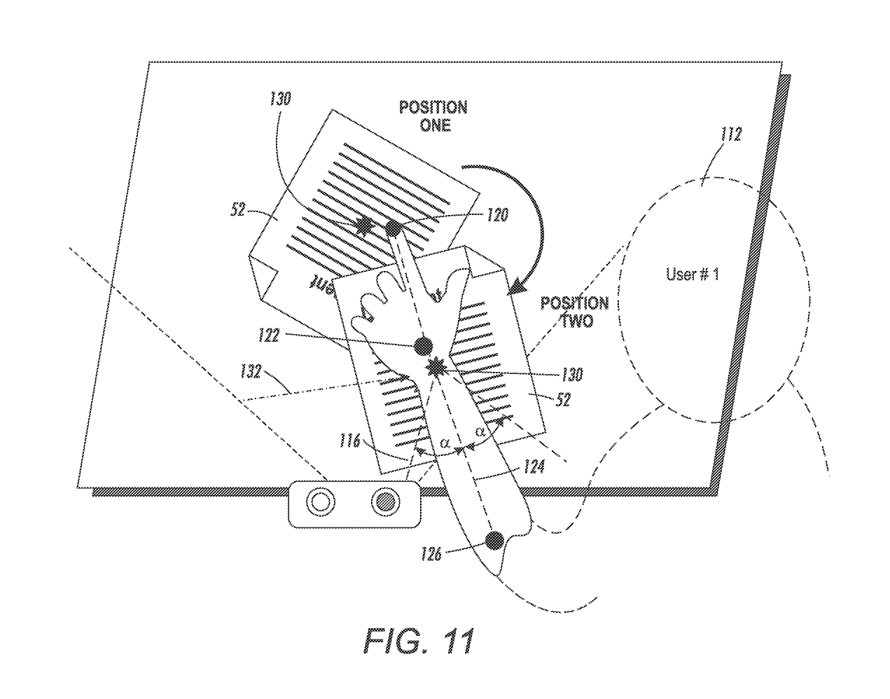

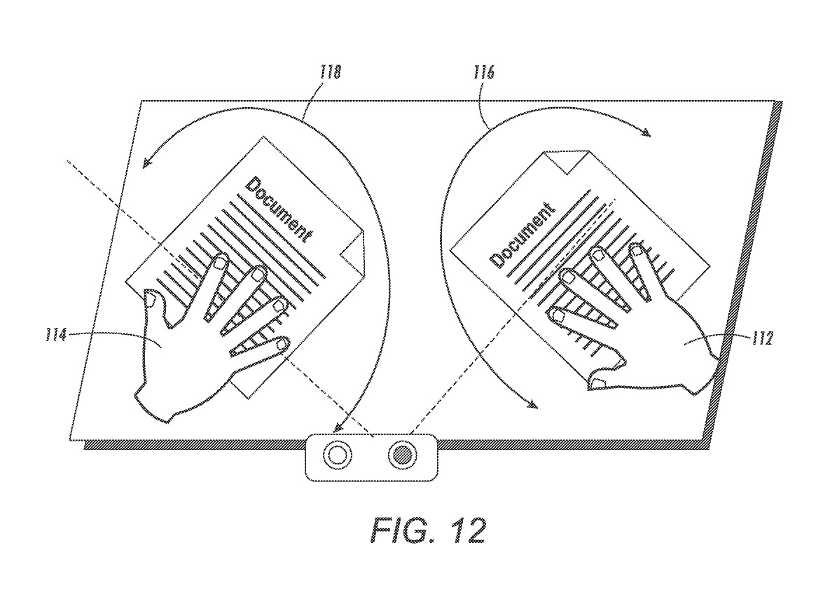

Users may also be working in large collaborative groups requiring multiple users to work around the display device 14. Using a 3D motion controller 42 allows multiple users to interact with the same document without disturbing other users, as described in the method shown in FIG. 10 and illustrated in FIGS. 11 and 12. The hand skeleton tracking provided by a 3D motion detector 38 provides an accurate indication of the orientation of the user's hand 84, which the 2D touch functionality has difficulty recognizing. Assuming that a user is always located at the same fixed side of the display screen 15 (e.g., bottom of the screen) is not appropriate as large touch screen devices 14 may be used as collaborative desktops with multiple users on multiple sides. The method of recognizing where a user is located with respect to the display screen 15 using the 3D motion controller 12 begins at S200.

At S202 the user makes a touch contact, e.g., double taps in the 2D space 16 over the document item 52, 54 to designate with which item the user intends to interact. At S204, the 3D motion controller 12 captures the orientation of the user's hand 84 over the display screen 14.

At S206, the 3D motion controller 12 uses a computed hand orientation, for example, determined from two or more detected points, such as the wrist and/or one or more fingers of the user's hand 84, to compute an approximate location of the user around the touch table and stores this information. In particular, the system detects the orientation of the user's hand with respect to the user's arm/body, for example, from detection of two or more positions 120, 122 on the user's hand and/or wrist. From the detected positions, the controller defines a wrist line 124 which extends from the user's hand to the expected position of the user's body 126 (FIG. 11).

At S208, the 3D motion controller 12 optionally uses the computed user location (around the display screen 14) and/or the wrist orientation to compute new expected coordinates of the document 52 center 130 and its new position on the screen with respect to the user in order to present the document in a suitable viewing position for the user.

At S210, the document 52 is relocated to the user's location and orientated to face the user (position 2).

At S212, once the document is positioned in front of the user, the 3D motion controller 12 optionally creates a workspace around the document 52, 54 by defining a limited set of authorized wrist orientations. In particular, from the identified wrist line 124, a range of accepted positions for the user's wrist line are defined, for example, the range being defined by an angle of ±a from the identified wrist line 124. Detected 3D and/or 2D hand gestures having a computed wrist line within the defined range can be attributed to the first user, while gestures with wrist lines (e.g., as shown at 132) outside this range are attributed to a second user. A boundary 116 may be created around the user's workspace. The workspace boundary may be generated automatically or through a first user's hand gesture, such as a 2D or 3D gesture (e.g., by double tapping on the center 130 of a displayed document above or a sweeping 3D motion in an arc which is illustrative of a boundary being drawn). This allows only the first user that requested the document 52 to interact and manipulate the document 52.

A second user is able to touch the same document 52 (for example, to show or designate content) without triggering any action on the document 52 as it is locked by the current user and only the limited set of authorized wrist orientations is recognized. The first user's 2D and/or 3D hand gestures can be used for implementing an item processing task on the displayed document/graphic objects within the respective boundary. For example, as shown in FIG. 12, a first user 112 has oriented a document for use in a first workspace while a second user 114 has orientated another document for user in a second workspace. Once the first and second users 112, 114 have locked a respective document to indicate their possession of that document, a workspace boundary 116, 118 may be formed around each document/workspace. This allows only the user who locked the document to make changes to the document. While other users can touch and show things on the locked document, these changes will not affect the locked document.

The method ends at S214.

### Attributes

In one embodiment, the displayed graphic objects represent a set of electronic text documents stored in memory. The attributes, in this case, can be based on the frequencies of keywords found in the documents, cluster-based attributes, generated by automatically assigning the documents to one of a set of clusters based on similarity, PLSA-based attributes as discussed above, or other attribute. For example, the attribute may be an identifier of a cluster to which the document is assigned after calculation of the clustering of a set of text documents, or any other attribute which can be extracted from the document, such as date sent, author, metadata, such as document size, document type, image content, and the like. Clustering of documents based on similarity is described for example, in U.S. Pub. Nos. 20070143101, 20070239745, 20080249999, and 20100088073, the disclosures of which are incorporated herein in their entireties by reference.

In another embodiment, the displayed graphic objects may represent a set of stored digital images, in which case the displayed objects may be icons or thumbnails of the images. The attributes, in this case, may be low level features of the images, such as color or texture, or higher level representations of the images based on the low level features extracted from patches of the image (see, for example, U.S. Pub. Nos. 20070005356; 20070143101, 20070239745, 20070258648; 20080069456; 20080240572; 20080249999, 20080317358; 20090144033; 20090208118; 20100040285; 20100082615; 20100088073; 20100092084; 20100098343; 20100189354; 20100191743; 20100226564; 20100318477; 20110026831; 20110040711; 20110052063; 20110072012; 20110091105; 20110137898; 20110184950; 20120045134; 20120076401; 20120143853, and 20120158739, the disclosures of which are incorporated herein in their entireties by reference), cluster-based attributes, as described above for documents, or classes automatically (e.g., based on the high level features) or manually assigned to the images, such as “cat,” “dog,” “landscape,” etc.

The method illustrated in FIG. 3 and/or 10 may be implemented in a computer program product that may be executed on a computer. The computer program product may be a non-transitory computer-readable recording medium on which a control program is recorded, such as a disk, hard drive, or the like. Common forms of computer readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data Signal using transmission media, such as acoustic or light waves, such as those generated during radio wave and infrared data communications, and the like.

The exemplary method(s) may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3 and/or 10, can be used to implement the method.

As will be appreciated some of the steps illustrated in FIG. 3 and/or 10 may be omitted and/or different steps may be included.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A document processing method comprising:
in memory, associating each of a plurality of hand gestures that are detectable with a three-dimensional sensor with a respective one of a plurality of item processing tasks, the three-dimensional sensor being associated with a touch sensitive display device, at least one touch gesture that is detectable with the touch sensitive display device being associated with at least one of the plurality of item processing tasks;
displaying a set of graphic objects on the touch sensitive display device, each graphic object being associated with a respective item;
with the three-dimensional sensor, detecting a hand gesture;
identifying the respective one of the item processing tasks that is associated with the detected hand gesture; and
implementing the identified one of the item processing tasks on the displayed graphic objects, comprising causing at least a subset of the displayed graphic objects to respond on the display device based on attributes of the respective items.

2. The method of claim 1, wherein at least one of the associating, displaying, detecting, identifying and implementing is performed with a computer processor.

3. The method of claim 1, wherein the plurality of item processing tasks are selected from the group consisting of classification tasks and clustering tasks.

4. The method of claim 3, wherein at least one of the item processing tasks is a classification task and wherein a first of the plurality of hand gestures is associated with filtering items that are positive for the class and a second of the plurality of hand gestures is associated with filtering items that are negative for the class.

5. The method of claim 4, wherein one of the first and second hand gestures corresponds to a palm of a user's hand facing upward and the other of the first and second hand gestures corresponds to a palm of the user's hand facing downward.

6. The method of claim 5, further comprising after detecting a hand gesture selected from the first and second hand gestures, causing a subset of the displayed graphic objects to move across the display device to follow the user's hand movement over the display device, the displayed graphic objects representing items that are respectively positive or negative for the class.

7. The method of claim 1, wherein the associating of at least some of the plurality of hand gestures comprises:
in response to the touch gesture, displaying a contextual menu on the touch-sensitive display device adjacent the user's hand, the contextual menu including a plurality of icons, each icon representing a respective one of the item processing tasks;
for each of at least some of the icons, associating a respective one of the hand gestures with the respective icon.

8. The method of claim 7, wherein the method includes detecting a finger touch on one of the icons of the menu and associating a gesture of the corresponding finger with the item processing task associated with the one of the icons of the menu.

9. The method of claim 1, wherein the detecting of the hand gesture comprises detecting movement of a user's hand over a group of the graphic objects displayed on the tactile user interface.

10. The method of claim 1, wherein the causing of the at least a subset of the displayed graphic objects to respond on the display device comprises causing the subset of graphic objects to change in at least one of a visible property of the subset of graphic objects and a position of the subset of graphic objects on the display device.

11. The method of claim 10, wherein the subset graphic objects on the display device change position in response to a detected movement of the user's hand relative to the display device.

12. The method of claim 11, wherein the method further comprises providing for detecting a hand gesture with the three-dimensional sensor that is associated in memory with releasing the subset of graphic objects and when the hand gesture associated with releasing the graphic objects is detected, causing the subset of graphic objects to become stationary at a location of the user's hand.

13. The method of claim 3, wherein the processing task includes a classification task and the method further comprising providing for detecting each of a plurality of predefined heights of a hand gesture, relative to the display device, with the three-dimensional sensor, each of the predefined heights being associated in memory with a respective classification threshold for a same class, and wherein when the user's hand is detected at one of the predefined heights, the implementing includes implementing a classification task at the respective classification threshold.

14. The method of claim 13, wherein the classification task based on the user's hand height is applied to a single graphic object.

15. The method of claim 3, wherein the processing task includes a classification task and the method further comprises:
activation of a classification mode in response to detection of a touch gesture on the touch-sensitive display device, including displaying a contextual menu of classification tasks;
providing for user selection of one of the classification tasks through interaction of the user's hand with the contextual menu;
associating the selected classification task with a hand gesture; and
with the sensor, detecting the hand gesture over the set of graphic objects, wherein graphic objects representing documents that are responsive to the classification task exhibit a response to the hand gesture.

16. The method of claim 3, wherein the processing task includes a clustering task and wherein the associating each of the plurality of hand gestures with a respective one of the plurality of item processing tasks comprises associating each of a number of clusters with a respective number of visible fingers in the hand gesture and wherein the implementing of the clustering tasks comprises partitioning the graphic objects into a number of clusters corresponding to a number of visible fingers detected by the sensor.

17. The method of claim 1 wherein at least one of:
the items comprise text documents and the attributes are computed based on words in the text documents;
the items comprise images and the attributes are computed based on visual features extracted from the images.

18. The method of claim 1, further comprising:
with the three-dimensional sensor, detecting an orientation of the user's wrist with respect to the user's hand; and
repositioning graphic objects on the display device, based on the detected wrist orientation such that the graphic objects are viewable by the user in a viewing orientation.

19. A computer program product comprising non-transitory memory storing instructions which when executed by a processor, perform the method of claim 1

20. An interactive user interface for processing items comprising:
a touch-sensitive display device;
a three-dimensional sensor for detection of hand gestures adjacent the display device;
instructions stored in memory for:
associating each of a plurality of hand gestures that are detectable with a three-dimensional sensor with a respective one of a plurality of item processing tasks, at least one of the item processing tasks being associated with a touch gesture detectable by the touch-sensitive display device,
displaying a set of graphic objects on the display, each graphic object representing a respective item,
with the three-dimensional sensor, detecting a hand gesture,
identifying the respective one of the item processing tasks that is associated with the detected hand gesture, and
implementing the identified one of the item processing tasks on the displayed graphic objects, comprising causing at least a subset of the displayed graphic objects to respond on the display device based on attributes of the respective items; and
a processor in communication with the memory and display for executing the instructions.

21. The user interface of claim 20, wherein the touch-sensitive display device serves as a tactile user interface for detection of two-dimensional hand motions.

22. A method for using 2D and 3D motion control on a common user interface comprising:
providing for receiving a 2D gesture on a graphic object displayed on a tactile user interface from a user's hand;
using a 3D sensor, capturing an orientation of the user's hand;
with a processor, calculating a location of the user from the hand orientation; and performing at least one of:
repositioning the graphic object on the tactile user interface, based on the detected hand orientation, such that the graphic objects are viewable by the user in a correct orientation to the user's location, and
creating a workspace boundary around the graphic objects of each of a plurality of users such that each user's hand gestures are used for implementing an item processing task on the displayed graphic objects within the respective boundary.
